(19) United States
(12) Patent Application Publication
(10) Pub. No.: US 2023/0252509 A1
(43) Pub. Date: Aug. 10, 2023

(54) AUTOMATED USER PLACEMENT WITHIN MERGED MULTI-LEVEL USER STRUCTURES

(71) Applicant: KWIKCLICK, LLC, Murray, UT (US)

(72) Inventor: Fred Cooper, Farmington, UT (US)

(21) Appl. No.: 18/090,346

(22) Filed: Dec. 28, 2022

Related U.S. Application Data
(63) Continuation-in-part of application No. 17/868,452, filed on Jul. 19, 2022, now abandoned.
(60) Provisional application No. 63/223,312, filed on Jul. 19, 2021.

(51) Int. Cl. G06Q 30/0208; G06Q 30/0207

(52) U.S. Cl. CPC G06Q 30/0208; G06Q 30/0236

(57) ABSTRACT

Disclosed herein is a system and method to any two or more MLMs to be merged into a multiline MLM system despite having different commission structures. Each member of the original MLMs is able to maintain their existing downlines without any changes. The system may further automatically suggest positions in the commission tree for new members based on specified criteria including such factors as geographic location, income level, occupation, gender, social or political disposition, etc.

### CROSS-REFERENCE TO RELATED APPLICATION

The present application is a continuation-in-part and claims the priority benefit of U.S. patent application Ser. No. 17/868,452 file Jul. 19, 2022, which claims the priority benefit of U.S. provisional application No. 63/223,312 filed Jul. 19, 2021, the disclosures of which are incorporated herein by reference.

### BACKGROUND OF THE INVENTION

### 1. Field of the Disclosure

The present disclosure is generally related to merging multi-level marketing systems.

### 2. Description of the Related Art

MLM companies are defined by a commission structure that is multi-level, such that a commission is payed to at least one member above the member who made a sale or purchase. However, there are multiple kinds of commission structures (e.g., binary, matrix, or unilevel). The problem is that merging these companies while maintaining the integrity of the existing commission tree has been unsuccessful when the two companies do not have the same kind of commission structure. Usually when companies with a different commission structure do merge, the two commission trees are simply kept separate and retain their traits and commission rates. Therefore, members of a binary commission structure are typically compelled to continue to build that structure even if other members of the now merged company are Unilevel. If the merged company does decide to attempt to merge the commission trees, it often ends with members feeling disoriented by changes in position and can bring sudden changes in what was steady income which is very upsetting to members when the change results in a loss of income.

Merging two or more MLMs of a different type is possible if they are merged into multiline MLM. The Multiline MLM comes with its own set of challenges. One problem that users of a multiline MLM system might have is deciding where in the new commission structure to place new members. Some users may want to focus on a few lines as if they were in a binary or matrix MLM in which case placing the right people in the right lines is pertinent. Others may want to place members directly under them if they expect high volume from those members but may not currently have an open line to do so.

There is a need for existing MLM companies to merge without having to either continue to keep the companies separate or upset members by rearranging the existing commission structures.

### SUMMARY OF THE CLAIMED INVENTION

Embodiments of the present invention include systems and methods for merging two or more MLM data structures into a merged multiline MLM data structure despite having different commission structures. Each member of the original MLMs is able to maintain their existing downlines without any changes. The system may further automatically suggest positions in the commission tree for new members based on specified criteria including such factors as geographic location, income level, occupation, gender, social or political disposition, etc.

### BRIEF DESCRIPTIONS OF THE DRAWINGS

FIG. 1 illustrates an exemplary network environment in which a multi-level marketing merger system may be implemented.

FIG. 2A illustrates an exemplary multiline MLM multiline user database.

FIG. 2B illustrates an exemplary multiline MLM commission structure.

FIG. 3 illustrates an exemplary multiline MLM sales database.

FIG. 4 illustrates an exemplary multiline MLM commission module.

FIG. 5 illustrates an exemplary multiline MLM commission rules database.

FIG. 6 illustrates an exemplary multiline MLM commission database.

FIG. 7 illustrates an exemplary multiline MLM additional line module.

FIG. 8 illustrates an exemplary multiline MLM merger module.

FIG. 9 illustrates an exemplary unilevel MLM unilevel base module.

FIG. 10A illustrates an exemplary unilevel MLM unilevel user database.

FIG. 10B illustrates an exemplary unilevel MLM commission structure.

FIG. 11 illustrates an exemplary matrix MLM matrix base module.

FIG. 12A illustrates an exemplary matrix MLM matrix user database.

FIG. 12B illustrates an exemplary matrix MLM commission structure.

FIG. 13 illustrates an exemplary binary MLM binary base module.

FIG. 14A illustrates an exemplary binary MLM binary user database.

FIG. 14B illustrates an exemplary binary MLM commission structure.

FIG. 15 illustrates an exemplary merged MLM user data collection module.

FIG. 16A illustrates an exemplary merged MLM merged user database.

FIG. 16B illustrates an exemplary merged MLM commission structure.

FIG. 17 illustrates an exemplary merged MLM new member module.

FIG. 18 illustrates an exemplary merged MLM new member database.

FIG. 19 illustrates an exemplary user device user device com. module.

FIG. 20 illustrates an exemplary user device user base module.

FIG. 21 illustrates an exemplary user device sponsor priority module.

FIG. 22 illustrates an exemplary user device sponsor suggestion module.

### DETAILED DESCRIPTION

Embodiments of the present invention include systems and methods for merging two or more MLM data structures into a merged multiline MLM data structure despite having different commission structures. Each member of the original MLMs is able to maintain their existing downlines without any changes. The system may further automatically suggest positions in the commission tree for new members based on specified criteria including such factors as geographic location, income level, occupation, gender, social or political disposition, etc.

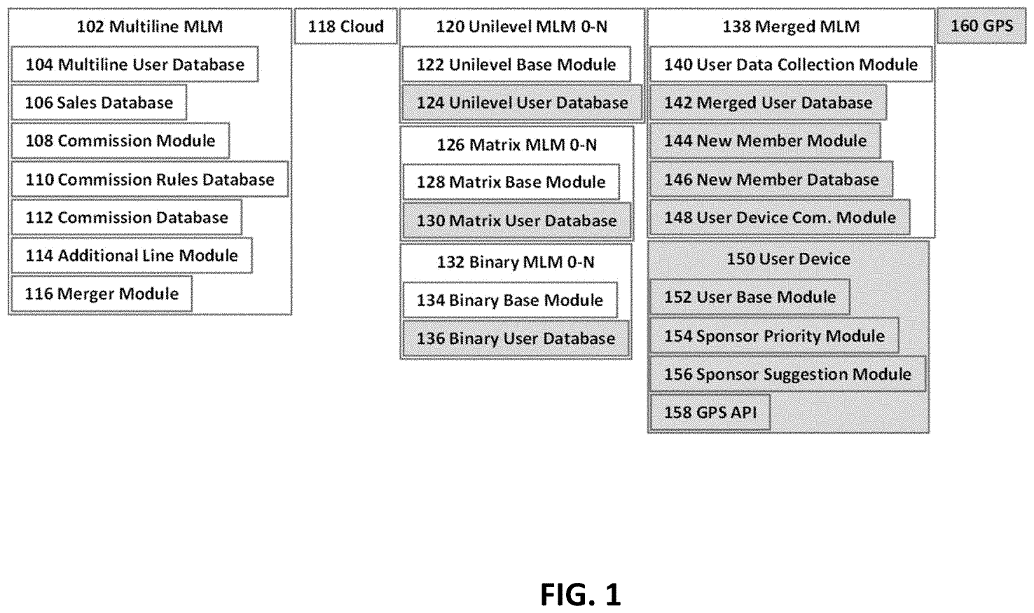

FIG. 1 illustrates an exemplary network environment in which a multi-level marketing merger system may be implemented. The network environment includes a multiline MLM data structure 102, which corresponds to data regarding a distribution organization characterized by a multi-level payment structure where each user of the organization is a distributor and pays commission to the user or users above them in the organization's structure. Such structure allows users to have an infinite number of lines corresponding to users below them paying commission, and the users below those users, and so on. In an embodiment, these additional lines may only be added once the users' initial lines meet a threshold volume or commission amount.

A multiline MLM multiline user Database 104 includes information on user's position in the multiline MLM 102 commission structure, who enrolled or sponsored the user in the multiline MLM 102, and how many lines the user is currently allowed.

A multiline MLM sales database 106 includes data on sales made by users, which is used by the multiline MLM commission module 108 to pay commissions to other users.

A multiline MLM commission module 108 calculates commission based on new sales data in the multiline MLM sales database 106 and stores that commission in the multiline MLM commission database 112. In some embodiments, the multiline MLM commission module 108 may also pay users directly.

A multiline MLM commission rules database 110 stores commission rules which are used by the multiline MLM commission module 108 to determine commissions.

A multiline MLM commission database 112 stores commissions calculated by the multiline MLM commission module 108, which are then used by the multiline MLM additional line module 114 to determine if the user qualifies for an additional line. In some embodiments, this data may be used by another module to pay commissions to users.

A multiline MLM additional line module 114 determines if the user has met the threshold commission value on their existing lines based on data from the multiline MLM commission database 112 and if so, adds an additional line to the number of lines that user is allowed.

A multiline MLM merger module 116 receives data from the unilevel MLM unilevel user database 124 via the unilevel MLM unilevel base module 122, MLM matrix user database 130 via the matrix MLM matrix base module 128, and binary MLM binary user database 136 via the binary MLM binary base module 134, makes sure the data includes the relevant metrics, and sends the data to the merged MLM user data collection module 140.

The cloud or communication network 118 may be a wired and/or a wireless network. The communication network 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 118 may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

A number of unilevel MLMs 120 are data structures for distribution organizations characterized by a multi-level payment structure where each user of the organization is a distributor and pays commission to the user or users above them in the organization's structure, and which allows users to have an infinite amount of lines corresponding to users below them paying commission, and the users below those users, etc., until a certain depth of users is reached. For example, if user 1 is above user 2, who is above user 3, who is above user 4, who is above user 5, etc. then users 2, 3, and 4 may pay commissions to user 1, but users 5, 6, 7, etc. do not pay commissions to user 1.

A unilevel MLM unilevel base module 122 extracts data from the unilevel MLM unilevel user database 124 and sends that data to the multiline MLM merger module 116 to be stored in the multiline MLM multiline user database 104.

A unilevel MLM unilevel user database 124 stores information on user's position in the unilevel MLM 120 commission structure, who enrolled or sponsored the user in the unilevel MLM 120, how many lines the user currently has, and personal information on the user such as name and address.

A number of matrix MLMs 126 are data structures corresponding to distribution organizations characterized by a multi-level payment structure where each user of the organization is a distributor and pays commission to the user or users above them in the organization's structure, and which allows users to have an fixed amount of lines, which are users below them paying commission, and the users below those users, etc., until a certain depth of users is reached. For example, if user 1 is above user 2, who is above user 3, who is above user 4, who is above user 5, etc. then users 2, 3, and 4 may pay commissions to user 1, but users 5, 6, 7, etc. do not pay commissions to user 1, and user 1 may only have a limited number of users directly below them (e.g., 5).

A matrix MLM matrix base module 128 extracts data from the matrix MLM matrix user database 130 and sends that data to the multiline MLM merger module 116 to be stored in the multiline MLM multiline user database 104.

A matrix MLM matrix user database 130 includes information on user's position in the matrix MLM 126 commission structure, who enrolled or sponsored the user in the matrix MLM 126, how many lines the user currently has, and personal information on the user such as name and address.

A number of binary MLMs 132 may be data structure corresponding to distribution organizations characterized by a multi-level payment structure where each user of the organization is a distributor and pays commission to the user or users above them in the organization's structure, and which allows users to have only 2 lines, which are users below them paying commission, and the users below those users, etc., for an unlimited amount of depth.

A binary MLM binary base module 134 extracts data from the binary MLM binary user database 136 and sends that data to the multiline MLM merger module 116 to be stored in the multiline MLM multiline user database 104.

A binary MLM binary user database 136 may store information on user's position in the binary MLM 132 commission structure, who enrolled or sponsored the user in the binary MLM 132, and personal information on the user such as name and address.

A merged MLM 138 may be a data structure for a new entity created from the merger of at least two MLM data structures, e.g., the merger of a unilevel MLM 120 and a binary MLM 132; a unilevel MLM 120, matrix MLM 126, and binary MLM 132; or 15 matrix MLMs 126 and one binary MLM 132. The merged MLM 138 receives data from the multiline MLM 102 in order to create an organizational structure that includes the members of the MLMs that have been merged. In some embodiments, the merged MLM 138 may not exist at the same time as some of the other components of this system, in which case the data on users may be temporarily or permanently stored in a database by the multiline MLM 102.

In some embodiments, the merged MLM 138 may correspond to the same legal entity as one of the MLMs being merged. For example, a binary MLM 132 may acquire a unilevel MLM 120 and convert to a multiline structure in order to absorb the members of the unilevel MLM 120, in which case the binary MLM 132 and merged MLM 138 are the same company or organization from a legal perspective.

A merged MLM user data collection module 140 receives user data from the multiline MLM merger module 116, which is then stored in the merged MLM merged user database 142 and includes data on users from the other MLMs that were merged to create the merged MLM 138.

A merged MLM merged user database 142 may store information on user's position in the merged MLM commission structure, who enrolled or sponsored the user in the merged MLM or one of the MLMs that was eventually merged into the merged MLM, the number of lines that user is allowed under a multiline commission structure, and personal information on the user such as name and address.

A merged MLM new member module 144 periodically searches the merged MLM new member database 146 for entries, determines if there is a place in the commission tree for that entry, and if so, removes that entry from the merged MLM new member database 146 and adds it to the merged MLM merged user database 142.

A merged MLM new member database 146 may store user data on new members that are intended to be placed in the commission tree, this data comes from the user device 150 via the user device user base module 152.

A merged MLM user device commission module 148 receives a request to connect from the user device user base module 152, then stores received data in the merged MLM new member database 146.

A user device 150 may include such computing devices as a laptop, smartphone, table, computer, or smart speaker.

A user device user base module 152 may connect with the merged MLM user device commission module 148 in order to handle requests for data from other modules, then initiates the user device sponsor priority module 154 and user device sponsor suggestion module 156.

A user device sponsor priority module 154 prompts the user for data on a new member, then prompts the user to assign a priority to that member, if a new member is assigned top priority then the member is intended to be placed in the immediate downline of the user and the new member's data will be sent immediately to the merged MLM new member module 144. If not, the member's data will be sent to the user device sponsor suggestion module 156.

A user device sponsor suggestion module 156 determines which lines are not yet at commission capacity and of those lines, which immediately downline user would be the closest geographically to the new member, then allows the user to select which line to place the new member in while indicating which line is suggested based on geographic location and which lines are not yet at capacity. In other embodiments, the user device sponsor suggestion module 156 may use different criteria for suggestions such as user income level, demographic information, political disposition, character traits, mutual acquittances, age, sex, gender, etc. Each of these criteria may be presented separately or combined into an overall suggested line.

A user device GPS API 158 allows the user device sponsor suggestion module 156 to determine the distance between an existing user and a new member based on their address using the GPS 160.

GPS 160 is a satellite-based radio navigation system owned by the United States government and operated by the United States Space Force. It is one of the global navigation satellite systems (GNSS) that provides geolocation and time information to a GPS receiver anywhere on or near the Earth. It can be used to determine the distance between any two locations on earth by means of satellite navigation. In some embodiments, instead of GPS, the systems and methods discussed herein may utilize other means of distance mapping such as traditional maps, a map database, a database of known distances, an alternate global navigation system, etc. at element 160.

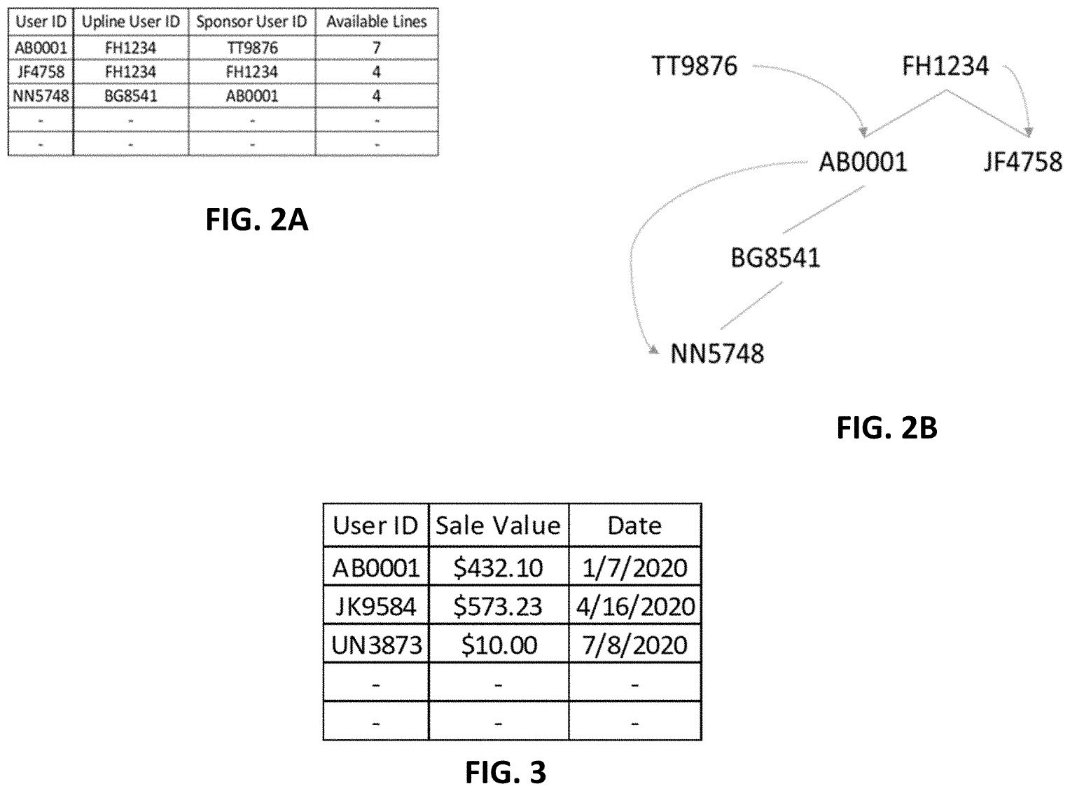

FIG. 2A illustrates an exemplary multiline MLM multiline user database 104, and FIG. 2B illustrates an exemplary multiline MLM commission structure. The multiline MLM multiline user database 104 includes a user ID (e.g., AB0001), information on user's position in the multiline MLM 102 commission structure, user ID of the user above them in the commission structure (e.g., FH1234), who enrolled or sponsored the user in the multiline MLM 102 (e.g., user ID TT9876), and how many lines the user is currently allowed (e.g., 7), users are assigned a default number of lines when they join the multiline MLM 102, users that were merged from another MLM. For example, the Unilevel MLM 120 will come into the multiline MLM 102 with at least the number of lines they had under their old MLM structure. In an embodiment, the default number of lines is 4.

FIG. 2B an exemplary multiline MLM commission structure based on the data in FIG. 2A, wherein the straight lines indicate an upline/downline relationship between two users and a curved, arrowed line indicates that the user the arrow points to was sponsored by the user the line originates from, more lines and users may exist than are shown.

FIG. 3 illustrates an exemplary multiline MLM sales database 106. The multiline MLM sales database 106 includes data on sales made by users, which includes a user ID (e.g., AB0001), a sale value (e.g, $432.10), and a transaction date (e.g., Jan. 7, 2020), which is used by the multiline MLM commission module 108 to pay commissions to other users. In some embodiments, the database may include more sales data such as the seller's ID if applicable, item IDs of the items sold, volume sold, payment method and data, etc.

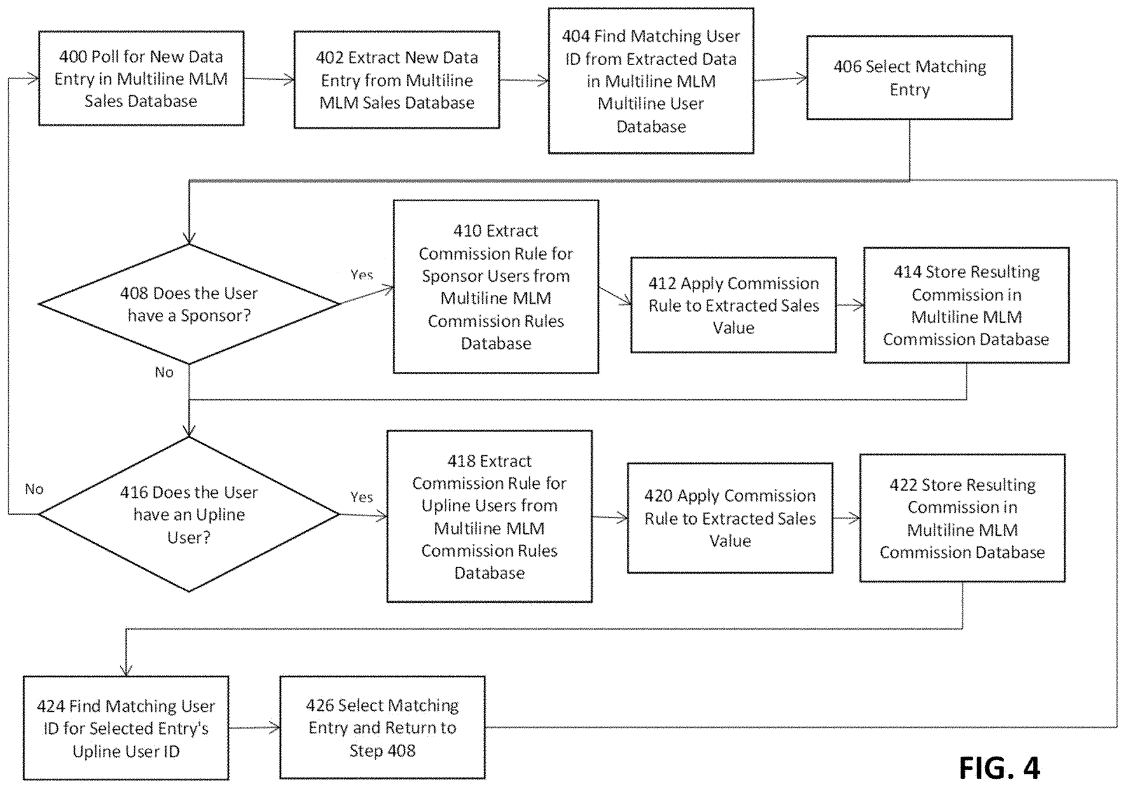

FIG. 4 illustrates an exemplary multiline MLM commission module 108. The process begins with the multiline MLM commission module 108 polling for a new data entry in the multiline MLM sales database 106 (e.g., when a sale is made by a user at step 400.

The multiline MLM commission module 108 extracts the new data entry from the multiline MLM sales database 106 which includes at least a user ID, sales value, and date at step 402.

The multiline MLM commission module 108 searches for a User ID in the multiline MLM multiline user database 104 that matches the user ID extracted from the multiline MLM sales database 106. For example, if the extracted user ID had a value of “AB0001,” then the multiline MLM commission module 108 will search the multiline MLM multiline user database 104 for a value of “AB0001” in the “User ID” category at step 404.

The multiline MLM commission module 108 selects the entry in the multiline MLM multiline user Database 104 with a matching user ID value at step 406.

At step 408, the multiline MLM commission module 108 determines if the user has a sponsor by checking the entry for a value in the “Sponsor User ID” category. Ff there is no value or the value does not correspond to a user ID, then the multiline MLM commission module 108 will skip to step 416.

If there is a value that corresponds to a user ID in the “Sponsor User ID” category, the multiline MLM commission module 108 extracts the commission rule from the multiline MLM commission rule database 110 for sponsor users at step 410.

At step 412, the multiline MLM commission module 108 applies the extracted commission rule to the sales value extracted from the multiline MLM sales database 106. For example, if the rule is 10% commission for sponsors and the sales value is $300, then $300 will be multiplied by 10% to get $30, which is the commission payable to the sponsor. In an embodiment, the sponsor may be paid directly by the multiline MLM commission module 108 after this step.

At step 414, \the multiline MLM commission module 108 stores the resulting commission in the multiline MLM commission database 112, along with the user ID of the sponsoring user to be paid, the user ID of the sponsored user, the commission type (e.g., sponsor), and the date extracted from the multiline MLM sales database 106. In some embodiments, the date may be changed to reflect a delay in the processing of the commission or payment of the commission.

At step 416, the multiline MLM commission module 108 determines if the user has an upline user by checking the entry for a value in the “Upline User ID” category. If there is no value, or the value does not correspond to a user ID then the multiline MLM commission module 108 will return to polling for a new data entry in the multiline MLM sales database 106.

If there is a value that corresponds to a user ID in the “Upline User ID” category, the multiline MLM commission module 108 extracts the commission rule from the multiline MLM commission rule database 110 for upline users at step 418.

At step 420, the multiline MLM commission module 108 applies the extracted commission rule to the sales value extracted from the multiline MLM sales database 106. For example, if the rule is 10% commission for upline users and the sales value is $300, then $300 will be multiplied by 10% to get $30 which is the commission payable to the upline user. In some embodiments, users may receive a different commission based on how many levels upline they are from the user who made the sale. For example, the upline user of the upline user may earn 5% commission, and next upline user may earn 1% commission. In an embodiment, the upline user may be paid directly by the multiline MLM commission module 108 after this step.

At step 422, the multiline MLM commission module 108 stores the resulting commission in the multiline MLM commission database 112, along with the user ID of the upline user to be paid, the user ID of the downline user, the commission type (e.g., upline), and the date extracted from the multiline MLM sales database 106. In some embodiments, the date may be changed to reflect a delay in the processing of the commission or payment of the commission.

The multiline MLM commission module 108 then searches the multiline MLM multiline user Database 104 for an entry where the user ID in the “User ID” category matches the user ID in the “Upline User ID” category of the currently selected entry at step 424.

The multiline MLM commission module 108 selects the entry with the matching user ID value as the new selected entry and returns to step 408 at step 426.

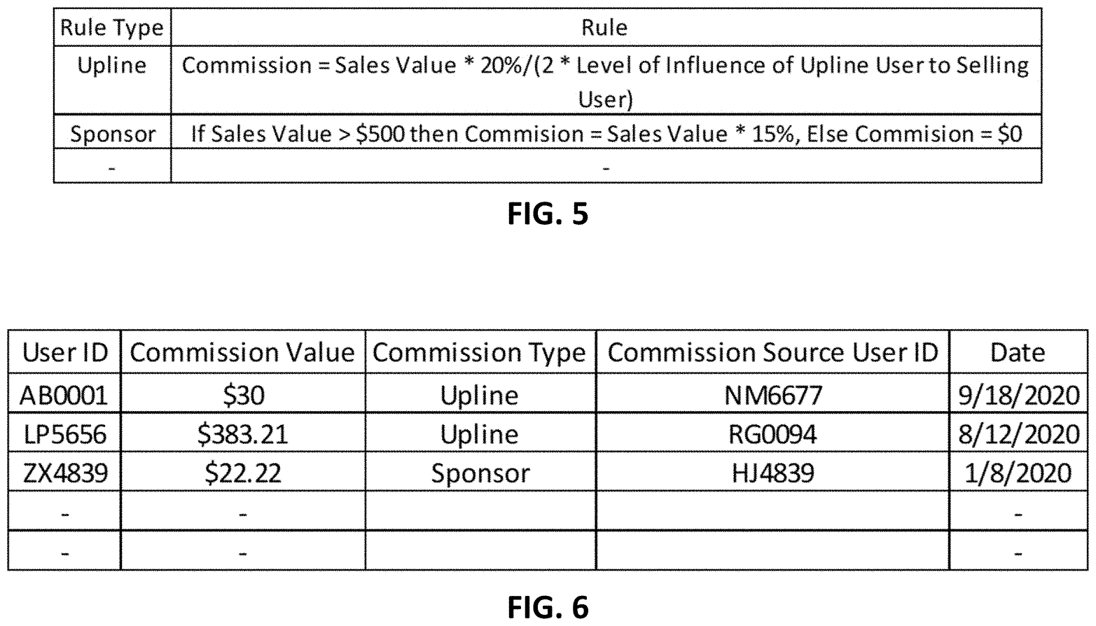

FIG. 5 illustrates an exemplary multiline MLM commission rules database 110. The multiline MLM commission rules database 110 includes commission rules, which are used by the multiline MLM commission module 108 to determine commissions. Commission rules can be complex or simple, but will often involve a mathematical calculation. For example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc. In another example, the rule may dictate that the commission for sponsors is 15% of the sale but only if the sale is over $500; otherwise no commission is paid, the database also includes the type of rule. For example, “Sponsor” indicates that the rule should be used to calculate commissions for sponsors. In some embodiments, multiple rules may exist for one rule type. For example, one rule may apply to sponsors that are also somewhere upline of the user who made the sale, while a different sponsor rule may apply if the sponsor is cross-line, meaning they are not anywhere upline of the user who made the sale.

FIG. 6 illustrates an exemplary multiline MLM commission database 112. The multiline MLM commission database 112 includes commissions calculated by the multiline MLM commission module 108, which are then used by the multiline MLM additional line module 114 to determine if the user qualifies for an additional line. In some embodiments, this data may be used by another module to pay commissions to users, which includes at least a user ID (e.g., AB0001), a commission value (e.g., $30), the type of commission (e.g., downline), the user ID of the user the commission came from (e.g., NM6677), and a date (e.g., Sep. 18, 2020). If the commission came from a sale made somewhere in a user's downline, then the commission will be considered to come from the immediately downline user. In other embodiments, the commission may be recorded as coming from the selling user.

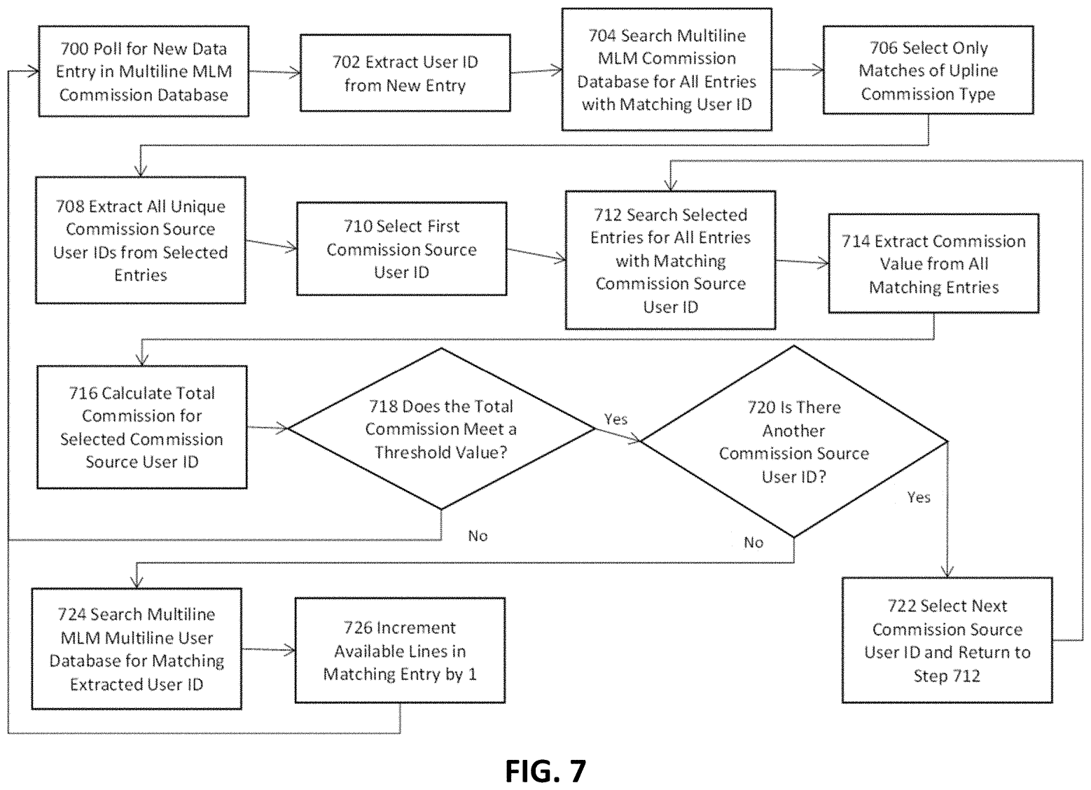

FIG. 7 illustrates an exemplary multiline MLM additional line module 114. The process begins with the multiline MLM additional line module 114 polling for a new data entry in the multiline MLM commission database 112 at step 700.

The multiline MLM additional line module 114 extracts the user ID from the User ID category in the new data entry (e.g., AB0001 at step 702.

The multiline MLM additional line module 114 searches the multiline MLM commission database 112 for all entries that also have the extracted user ID in the User ID category, which is data on all the commissions that have been paid to that user at step 704.

The multiline MLM additional line module 114 selects all the matching entries that also have “upline” in the Commission Type category at step 706.

At step 708, the multiline MLM additional line module 114 extracts all the user IDs in the Commission Source User ID category of the entries, ignoring repeats. Each of these user IDs corresponds to a user that is directly downline of the user who's user ID was extracted from the new data entry, and therefore each correspond to a line. In some embodiments, lines that have not yet made sales may be accounted for by creating a null or nominal commission upon creation. For example, if user AB0001 places user CD0002 in their immediate downline a record may be recorded in the multiline MLM commission database 112 for $0.01 or $0.00 so that CD0002 is recognized as the start of one of AB0001's downlines.

The multiline MLM additional line module 114 selects the first of the extracted Commission Source User IDs, which may be determined by, e.g., alphabetical order or most recent commission at step 710.

The multiline MLM additional line module 114 searches the entries selected in step 706 for all entries that match the commission source user ID selected in the Commission Source User ID category, which will find all the entries that correspond to commissions made by a single line at step 712.

At step 714, the multiline MLM additional line module 114 extracts the commission value in the Commission Value Category for each matching entry. In some embodiments, the commissions are further filtered by a time frame (e.g., only commission values from commissions made in the last month will be extracted.

The multiline MLM additional line module 114 totals the extracted commission values by adding them all together to get the total commission from that line at step 716.

At step 718, the multiline MLM additional line module 114 determines if the total commission calculated meets a threshold value, the threshold value is a value that all lines meet before a user is allowed to have a new line. For example, if the user has 7 lines, each line has made over $1000 in commission, and the threshold value is $1000. Then the user will be allowed to create an 8th line. The threshold value can be fixed or variable. In an embodiment, the threshold value is stored in a database and retrieved by the multiline MLM additional line module 114. If the total commission calculated fails to meet the threshold value, then the user cannot receive a new line, because all lines meet the threshold value. The multiline MLM additional line module 114 will return to polling for a new data entry in the multiline MLM commission database 112.

If the total commission calculated meets the threshold value, the multiline MLM additional line module 114 determines if there is another commission source user ID that was extracted in step 708 at step 720.

If there is another commission source user ID, the multiline MLM additional line module 114 selects the next commission source user ID and returns to step 712 at step 722.

If there is not another commission source user ID, the multiline MLM additional line module 114 searches the multiline MLM multiline user database 104 for an entry that matches the user ID extracted from the new entry in step 702 in the User ID category at step 724.

At step 726, the multiline MLM additional line module 114 increments the number in the Available Lines category of the matching entry by 1, which allows the user to create one additional line. In some embodiments, the number in the Available Lines category of the matching entry may be changed in another way (e.g., increased by 2, multiplied by 1.2 and rounded to the nearest whole number, squared, etc.

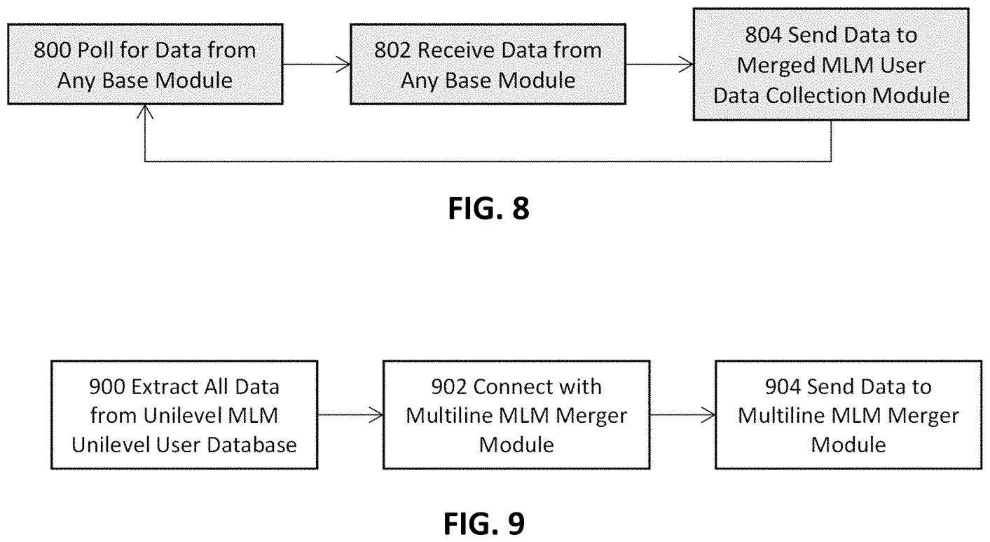

FIG. 8 illustrates an exemplary multiline MLM merger module 116. The process begins with the multiline MLM merger module 116 polling for data from the unilevel MLM unilevel base module 122, matrix MLM matrix base module 128, or binary MLM binary base module 134. This data is extracted by the Base Module of each type of MLM from the respective database of user data at step 800.

The multiline MLM merger module 116 receives data from the unilevel MLM unilevel base module 122, matrix MLM matrix base module 128, or binary MLM binary base module 134, which includes a user ID (e.g., AB0001), information on user's position in the multiline MLM 102 commission structure via the user ID of the user above them in the commission structure (e.g., FH1234), who enrolled or sponsored the user in the multiline MLM 102 (e.g., user ID TT9876), and how many lines the user currently has in the Unilevel MLM 120 (e.g., 7). In some embodiments, where the number of lines is restricted, then the number of lines may not be included with each user but sent as one value. For example, a binary MLM 132 may be assumed to allow 2 lines for each user, and a matrix MLM 126 may have a known maximum number of lines (e.g., 5), which is already accounted for by the system or sent to the multiline MLM merger module 116 alongside the user data at step 802.

The multiline MLM merger module 116 sends the data to the merged MLM user data collection module 140 to be stored in the merged MLM merged user database 142. In an embodiment, user data without a number of lines will be set to the default value. For example, data from a binary MLM 132 may not include data for the number of lines, because all members of a binary MLM 132 may have 2 available lines, in which case the data will be amended to include the default number of lines that would be assigned to a new member of the merged MLM 138. In an embodiment, if the number of lines a user has is less than the default value it will be set to the default value. In an embodiment, the default value is 4 lines at step 804.

FIG. 9 illustrates an exemplary unilevel MLM unilevel base module 122. The process begins with the unilevel MLM unilevel base module 122 extracts all the data stored in the unilevel MLM unilevel user database 124 at step 900. The unilevel MLM unilevel base module 122 connects with the multiline MLM merger module 116 through the 118 Cloud or Internet, via a physical connection, or by any other method of transferring data at step 902. The unilevel MLM unilevel base module 122 sends the data extracted from the unilevel MLM unilevel user database 124 to the multiline MLM merger module 116 at step 904.

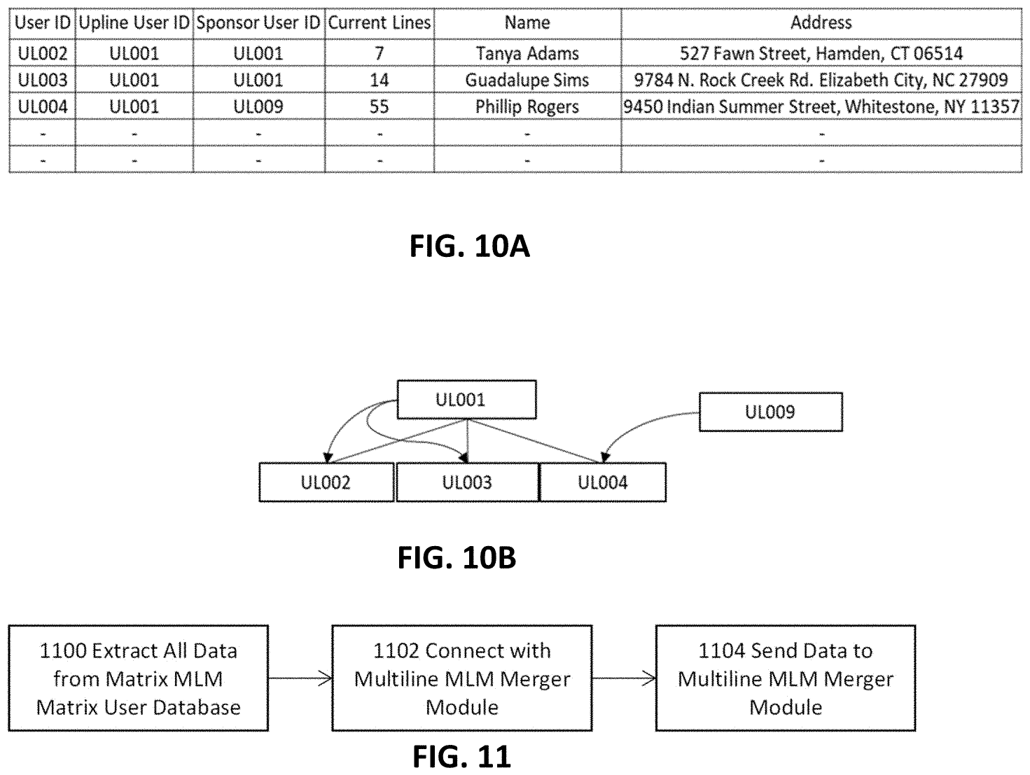

FIG. 10A illustrates an exemplary unilevel MLM unilevel user database 124, and FIG. 10B illustrates an exemplary unilevel MLM commission structure. The unilevel MLM unilevel user database 124 includes information on user's position in the Unilevel MLM 120 commission structure, who enrolled or sponsored the user in the Unilevel MLM 120, and how many lines the user currently has, which includes a user ID (e.g., UL002), information on user's position in the multiline MLM 102 commission structure, the user ID of the user above them in the commission structure (e.g., UL001), who enrolled or sponsored the user in the multiline MLM 102 (e.g., user ID UL009, how many lines the user currently has within the existing Unilevel MLM 120 (e.g., 7), and personal information such as the user's name (e.g., Tanya Adams), and address (e.g., 527 Fawn Street, Hamden, Conn. 06514). In some embodiments, additional personal information may be included in the database such as phone number, email address, known IP address, social security number, driver's license number, security question answers, or any other information which may help identify the user.

FIG. 10B illustrates an exemplary unilevel MLM commission structure based on the data in FIG. 10A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 11 illustrates an exemplary matrix MLM matrix base module 128. The process begins with the matrix MLM matrix base module 128 extracts all the data stored in the 130 Matrix MLM Matrix User Database at step 1100.

The matrix MLM matrix base module 128 connects with the multiline MLM merger module 116 through the 118 Cloud or Internet, via a physical connection, or by any other method of transferring data at step 1102.

The matrix MLM matrix base module 128 sends the data extracted from the matrix MLM matrix user database 130 to the multiline MLM merger module 116 at step 1104.

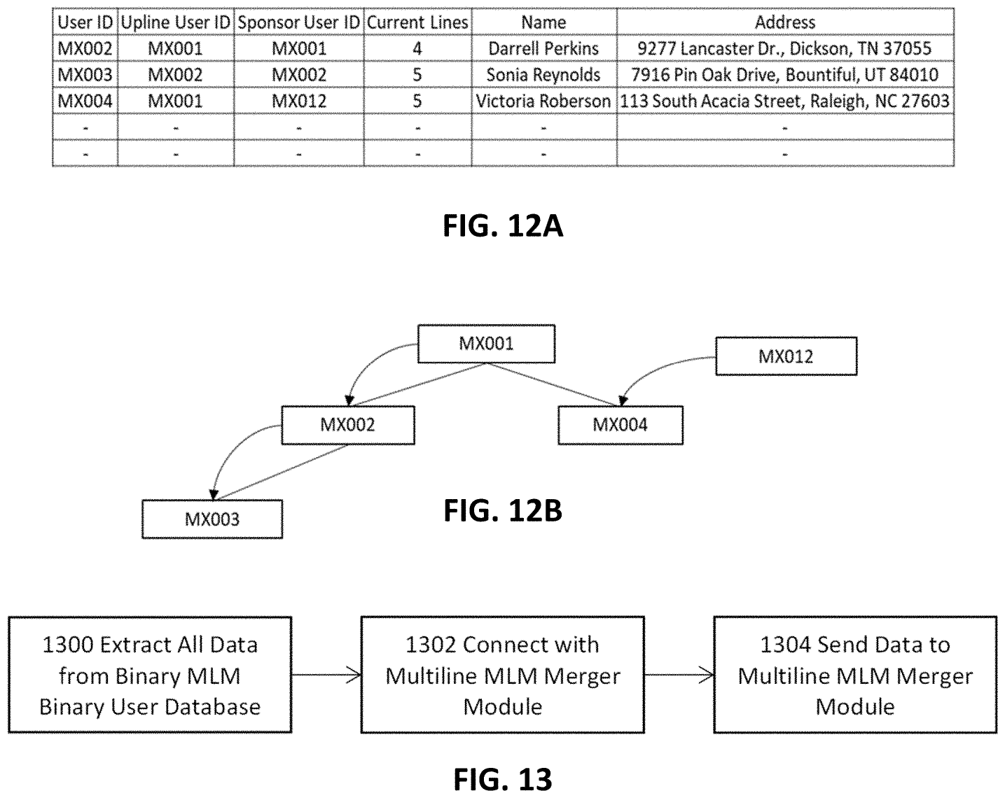

FIG. 12A illustrates an exemplary matrix MLM matrix user database 130, and FIG. 12B illustrates an exemplary matrix MLM commission structure. The matrix MLM matrix user database 130 includes information on user's position in the matrix MLM 126 commission structure, who enrolled or sponsored the user in the matrix MLM 126, and how many lines the user currently has, which includes a user ID (e.g., MX002), information on user's position in the matrix MLM 126 commission structure, for example the user ID of the user above them in the commission structure (e.g., MX001), who enrolled or sponsored the user in the matrix MLM 126 (e.g., MX001), how many lines the user currently has within the existing matrix MLM 126 (e.g., 5), and personal information such as the user's name (e.g., Darrell Perkins), and address (e.g., 9277 Lancaster Dr., Dickson, Tenn. 37055). In some embodiments, additional personal information may be included in the database such as phone number, email address, known IP address, social security number, driver's license number, security question answers, or any other information which may help identify the user. In an embodiment, the number of lines a user currently has may not be necessary as all users under a matrix MLM 126 can be assumed to have the maximum allowed for that structure. For example, in a matrix MLM 126 where the maximum amount of lines is 5, all users will be given a default 5 lines after being merged into the multiline MLM 102.

FIG. 12B illustrates an exemplary matrix MLM commission structure based on the data in FIG. 12A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 13 illustrates an exemplary binary MLM binary base module 134. The process begins with the binary MLM binary base module 134 extracts all the data stored in the binary MLM binary user database 136 at step 1300.

The binary MLM binary base module 134 connects with the multiline MLM merger module 116 through the cloud or Internet 118, via a physical connection, or by any other method of transferring data at step 1302.

The binary MLM binary base module 134 sends the data extracted from the binary MLM binary user database 136 to the multiline MLM merger module 116 at step 1304.

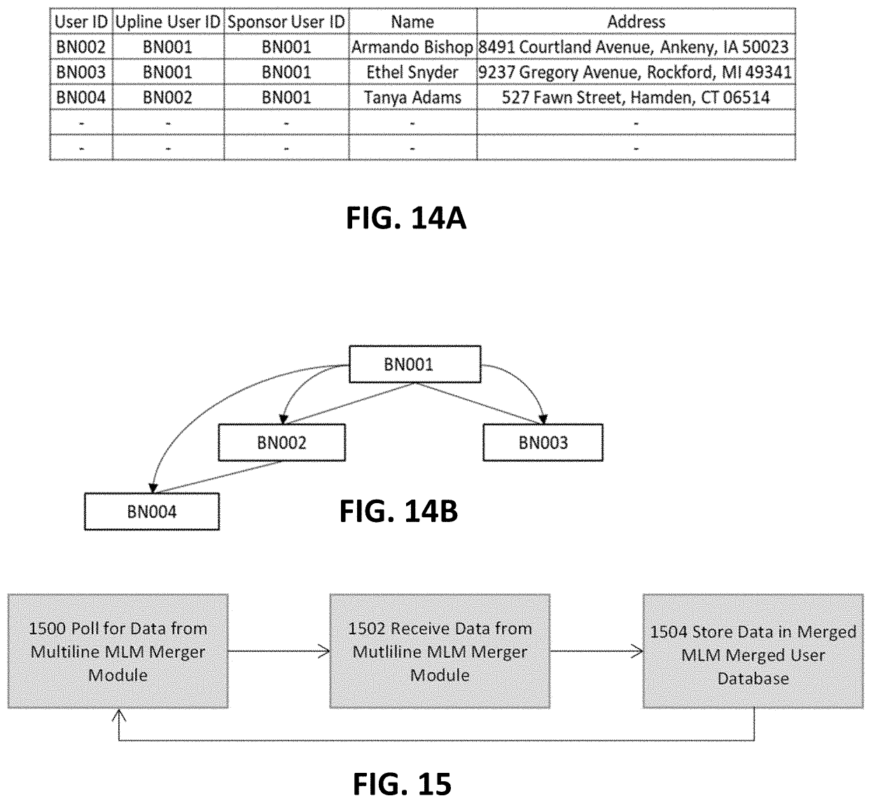

FIG. 14A illustrates an exemplary binary MLM binary user database 136, and FIG. 14B illustrates an exemplary binary MLM commission structure. The binary MLM binary user database 136 includes information on user's position in the binary MLM 132 commission structure, who enrolled or sponsored the user in the binary MLM 132, and how many lines the user currently has, which includes a user ID (e.g., BN002), information on user's position in the binary MLM 132 commission structure, for example the user ID of the user above them in the commission structure (e.g., BN001, who enrolled or sponsored the user in the binary MLM 132 (e.g., user ID BN001), how many lines the user currently has within the existing binary MLM 132 (e.g., 7), and personal information such as the user's name (e.g., Armando Bishop), and address (e.g., 8491 Courtland Avenue, Ankeny, Iowa 50023). In some embodiments, additional personal information may be included in the database such as phone number, email address, known IP address, social security number, driver's license number, security question answers, or any other information which may help identify the user.

FIG. 14B illustrates an exemplary binary MLM commission structure based on the data in FIG. 14A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown.

FIG. 15 illustrates an exemplary merged MLM user data collection module 140. The process begins with the merged MLM user data collection module 140 polling for data from the multiline MLM merger module 116 at step 1500.

The merged MLM user data collection module 140 receives data from the multiline MLM merger module 116 at step 1502. The merged MLM user data collection module 140 stores the received data in the merged MLM merged user database 142 at step 1504.

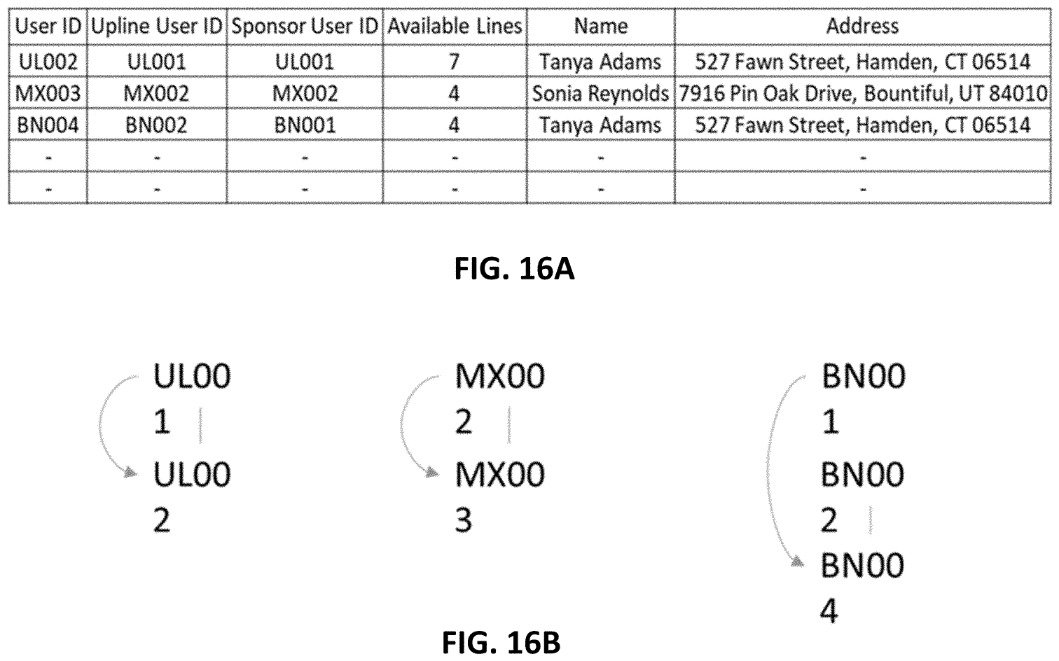

FIG. 16A illustrates an exemplary merged MLM merged user database 142, and FIG. 16B illustrates an exemplary merged MLM commission structure. The merged MLM merged user database 142 includes a user ID (e.g., UL002), information on user's position in the merged MLM 138 commission structure, for example the user ID of the user above them in the commission structure (e.g., UL001), who enrolled or sponsored the user in the merged MLM 138 or the original MLM that was merged into the merged MLM 138 (e.g., user ID UL001), how many lines the user is currently allowed (e.g., 7), and personal information such as the user's name (e.g., Tanya Adams), and address (e.g., 527 Fawn Street, Hamden, Conn. 06514). In some embodiments, additional personal information may be included in the database such as phone number, email address, known IP address, social security number, driver's license number, security question answers, or any other information which may help identify the user, users are assigned a default number of lines when they join the merged MLM 138, users that were merged from another MLM. For example, the unilevel MLM 120 will come into the merged MLM 138 with at least the number of lines they had under their old MLM structure. In an embodiment, the default number of lines is 4.

FIG. 16B illustrates an exemplary merged MLM commission structure based on the data in FIG. 16A, wherein the straight lines indicate an upline/downline relationship between two users and a curved, arrowed line indicates that the user the arrow points to was sponsored by the user the line originates from, more lines and users may exist than are shown, element 1600.

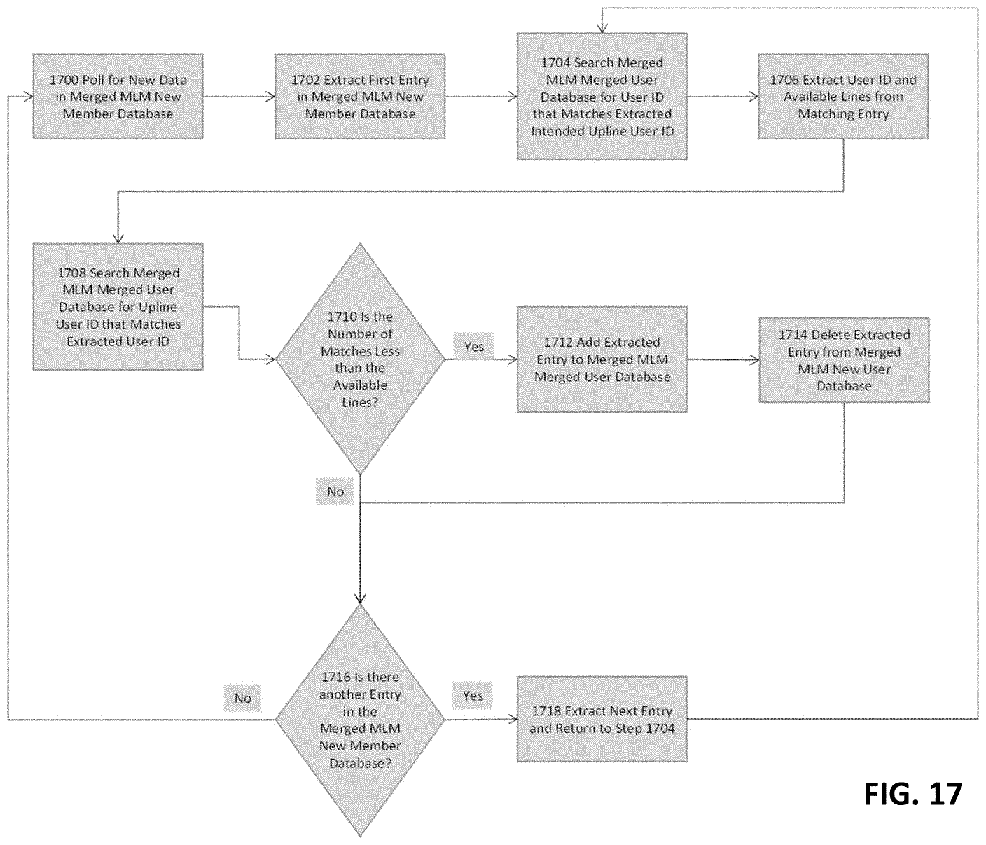

FIG. 17 illustrates an exemplary merged MLM new member module 144. The process begins with the merged MLM new member module 144 polling for new data in the merged MLM new member database 146 in step 1700. In another embodiment, the merged MLM new member module 144 is initiated periodically (e.g., every hour.

The merged MLM new member module 144 extracts the first entry in the merged MLM new member database 146 at step 1702.

The merged MLM new member module 144 searches the merged MLM merged user database 142 for an entry with a user ID in the “User ID” category that matches the user ID in the “Intended Upline User ID” category of the extracted entry at step 1704.

The merged MLM new member module 144 extracts the user ID and available lines from the matching entry at step 1706.

The merged MLM new member module 144 searches the merged MLM merged user database 142 for all entries with a user ID in the “Upline User ID” category that matches the extracted user ID at step 1708.

The merged MLM new member module 144 determines if the number of matching entries is less than the number of available lines, meaning the user has unoccupied lines available, if not the merged MLM new member module 144 skips to step 1716 at step 1710.

At step 1712, if the number of matching entries is less than the number of available lines, the merged MLM new member module 144 adds the extracted entry to the merged MLM merged user database 142. The user ID in the “Intended Upline User ID” category of the extracted data becomes the user ID in the “Upline User ID” category in the database, and the user is assigned a unique user ID.

The merged MLM new member module 144 deletes the extracted entry from the merged MLM new member database 146 at step 1714.

The merged MLM new member module 144 determines if there is another entry in the merged MLM new member database 146; if not the merged MLM new member module 144 returns to polling for new data in the merged MLM new member database 146 at step 1716.

If there is another entry in the merged MLM new member database 146, the merged MLM new member module 144 extracts the next entry and returns to step 1704 at step 1718.

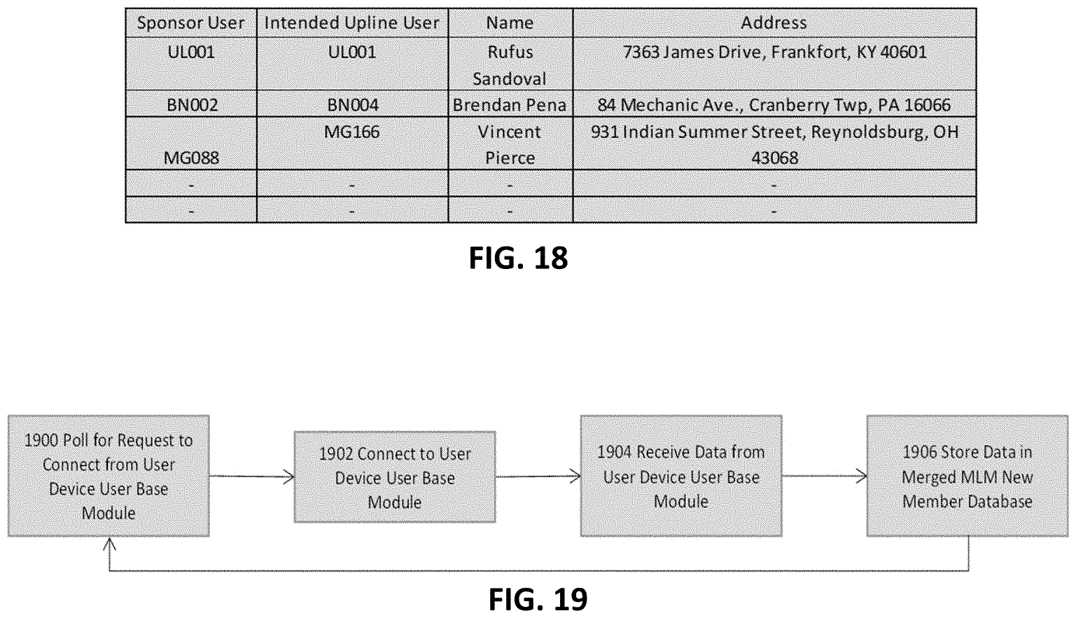

FIG. 18 illustrates an exemplary merged MLM new member database 146. The merged MLM new member database 146 includes user data on new members that are intended to be placed in the commission tree, this data comes from the user device 150 via the user device user base module 152, which consists of a user ID (e.g., UL001), intended upline user ID (e.g., UL 001), a name (e.g., Rufus Sandoval), and an address (e.g., 7363 James Drive, Frankfort, Ky. 40601). In some embodiments, additional data may be stored in the database.

FIG. 19 illustrates an exemplary user device user device com. Module 148. The process begins with the merged MLM user device commission module 148 polling for a request to connect from the user device user base module 152 at step 1900.

The merged MLM user device commission module 148 connects to the user device user base module 152 at step 1902.

The merged MLM user device commission module 148 receives data on a new member from the user device user base module 152 at step 1904.

The merged MLM user device commission module 148 stores the data in the merged MLM new member database 146 and returns to polling for a request to connect from the user device user base module 152. In an embodiment, the connection continues and the merged MLM user device commission module 148 polls for new data instead at step 1906.

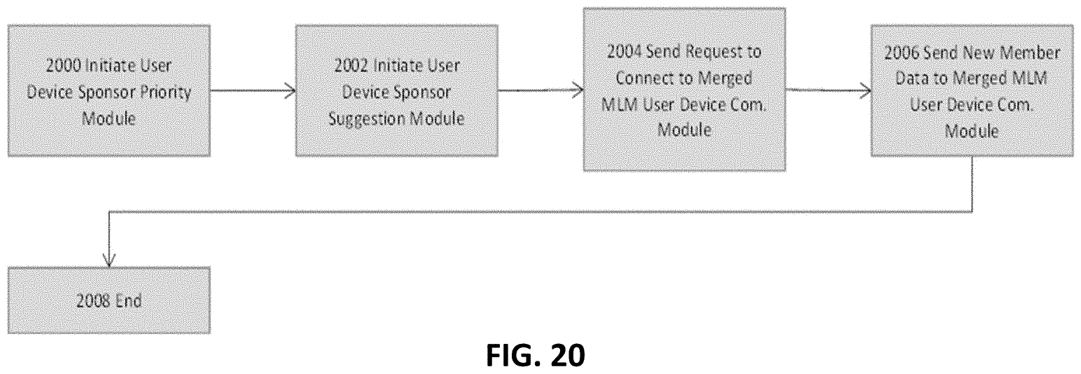

FIG. 20 illustrates an exemplary user device user base module 152. The process begins with the user device user base module 152 initiating the user device sponsor priority module 154 at step 2000.

The user device user base module 152 initiates the user device sponsor suggestion module 156 at step 2002.

The user device user base module 152 sends a request to connect to the merged MLM user device commission module 148 at step 2004.

The user device user base module 152 sends new member data from either the user device sponsor priority module 154 or the user device sponsor suggestion module 156 to the merged MLM user device commission module 148 at step 2006.

The user device user base module 152 ends. In an embodiment, the module will run on a loop and allow users to add additional members until the user manually ends the module at step 2008.

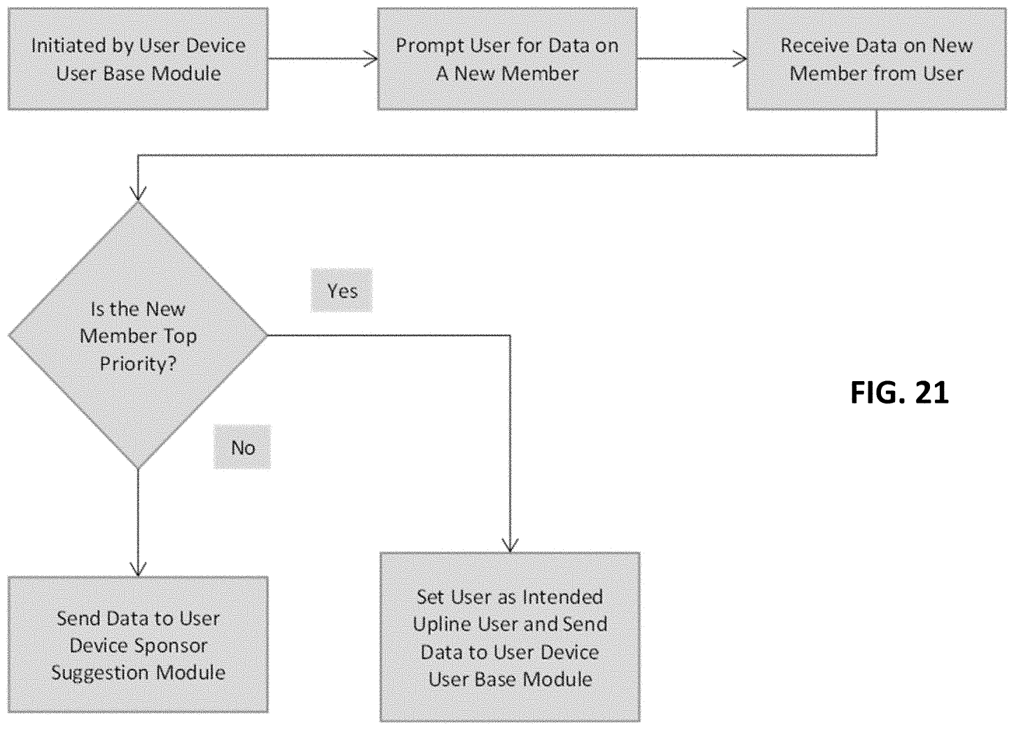

FIG. 21 illustrates an exemplary user device sponsor priority module 154. The process begins with the user device sponsor priority module 154 being initiated by the user device user base module 152 at step 2100.

At step 2102, the user device sponsor priority module 154 prompt the user to enter data on a new member that they are sponsoring. This data includes the member's name and address.

The user device sponsor priority module 154 receives the data on the member from the user. In some embodiments, this may be facilitated by a GUI at step 2104.

At step 2106, the user device sponsor priority module 154 determines if the new member is a top priority for the user, by prompting the user to enter “Y” or “N” in response to a question (e.g., “Do you want this member to be directly downline of you?”). In some embodiments, this may be facilitated by a GUI.

If the new member is a top priority for the user, the user device sponsor priority module 154 sets the user's ID as the intended upline user ID and sends the user's ID, indented upline ID, new member's name, and address to the user device user base module 152 to be sent to the merged MLM 138 and stored in the merged MLM new member database 146 at step 2108.

If the new member is not a top priority for the user, the user device sponsor priority module 154 sends the data to the user device sponsor suggestion module 156 at step 2110.

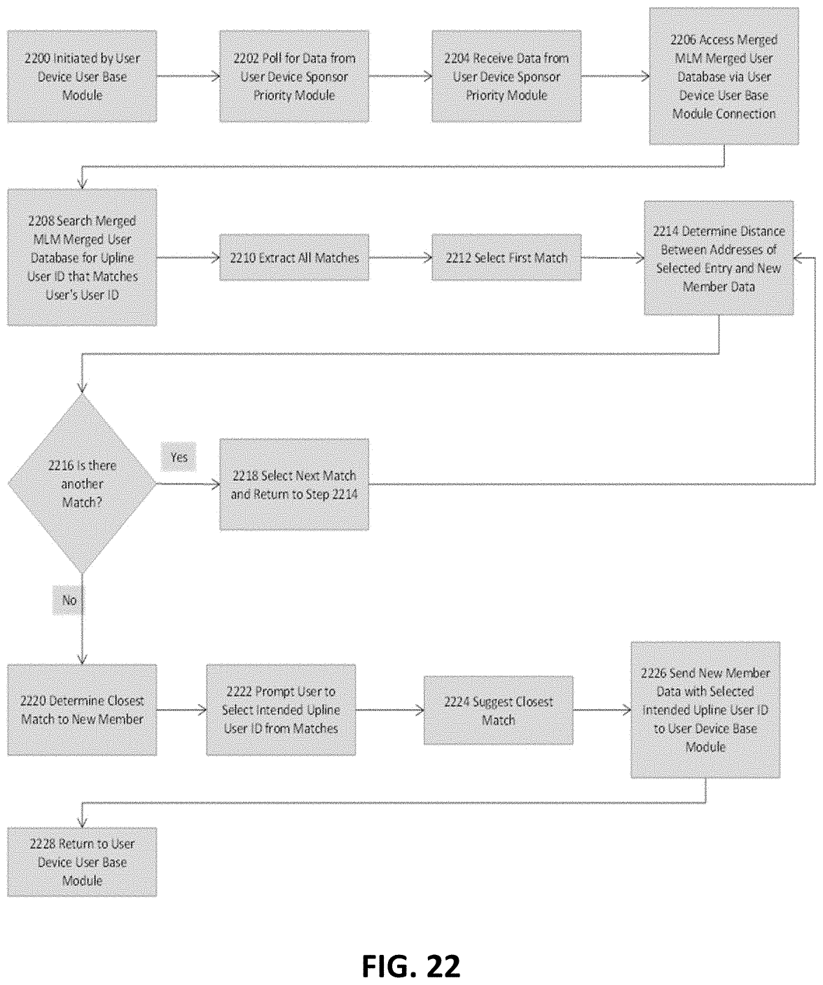

FIG. 22 illustrates an exemplary user device sponsor suggestion module 156. The process begins with *the user device sponsor suggestion module 156 being initiated by the user device user base module 152 at step 2200.

The user device sponsor suggestion module 156 polls for data from the user device sponsor priority module 154 at step 2202.

The user device sponsor suggestion module 156 receives data from the user device sponsor priority module 154 at step 2204.

The user device sponsor suggestion module 156 accesses the merged MLM merged user database 142 via the connection with the merged MLM 138 created by the user device user base module 152 at step 2206.

At step 2208, the user device sponsor suggestion module 156 searches the merged MLM merged user database 142 for all entries with a user ID in the “Upline User ID” category that matches the user ID of the user. In some embodiments, the user ID may be linked with the user device 150.

The user device sponsor suggestion module 156 extracts all matching entries from the merged MLM merged user database 142 at step 2210.

The user device sponsor suggestion module 156 selects the first extracted match at step 2212.

At step 2214, the user device sponsor suggestion module 156 determines the distance between the addresses of the selected entry and the new member, by using the GPS 160 via the user device GPS API 158. In some embodiments, the distance may instead be travel time.

The user device sponsor suggestion module 156 determines if there is another match extracted from the merged MLM merged user database 142 at step 2216.

If there is another match extracted from the merged MLM merged user database 142, the user device sponsor suggestion module 156 selects the next match and returns to step 2214 at step 2218.

If there isn't another match extracted from the merged MLM merged user database 142, the user device sponsor suggestion module 156 determines which of the matching entry's address is the shortest distance from the new member's address at step 2220.

The user device sponsor suggestion module 156 prompts the user to select one of the user IDs in the “User ID” category of the extracted entries to be the intended upline user ID for the new member at step 2222.

At step 2224, the user device sponsor suggestion module 156 suggests the closest match by outputting a message to the user (e.g., “We suggest placing [NEW MEMBER NAME] under [SUGGESTED ENTRY NAME] because they are nearby”. In some embodiments, this suggestion may be facilitated by a GUI and the suggested match may be highlighted or bolded.

At step 2226, the user device sponsor suggestion module 156 sends the new member data with the user's selection of intended upline user ID to the user device user base module 152 which will be sent to the merged MLM new member database 146.

The user device sponsor suggestion module 156 returns to the 152 User Device Base Module at step 2228.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

1. (canceled)

2. A method for merging at least two user structures into a multiline user structure, the method comprising:
storing information in a database regarding at least a first user structure with a first set of lines corresponding to existing relationships and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure; and
storing the merged multiline user structure in memory, wherein the merged multiline user structure is updateable to add one or more additional lines based on information from a global positioning system (GPS) of one or more new members associated with the one or more additional lines.

3. The method of claim 2, further comprising generating a graphical user interface that includes a suggestion of the one or more additional lines.

4. The method of claim 3, wherein generating the suggestion is based on a physical distance between the at least one member and one of the new members based on information provided by the GPS.

5. The method of claim 3, wherein generating the suggestion is based on a travel time between the at least one member and one of the new members based on information provided by the GPS.

6. The method of claim 2, further comprising identifying a physical address of the at least one member and a physical address of the new member, wherein generating the suggestion is based on the physical address.

7. The method of claim 2, further comprising identifying IP address of the at least one member and a physical address of the new member, wherein generating the suggestion is based on the IP address.

8. The method of claim 2, further comprising assigning a priority to the new member based on a request received from the at least one member.

9. The method of claim 2, further comprising modifying the set of relationships of the at least one member based the set of relationships exceeding a threshold maximum number.

10. The method of claim 9, further comprising comparing GPS information of the at least one member to GPS information of another member, wherein modifying the set of relationships includes creating a relationship between a new member to the other member.

11. The method of claim 2, further comprising adding one or more additional lines to the merged multiline user structure corresponding to new relationships with the at least one member until a threshold maximum number is reached.

12. The method of claim 11, further comprising raising the threshold maximum number based on threshold criteria being met.

13. The method of claim 12, further comprising identifying that the threshold criteria are met based on weighting one or more of the relationships between the at least one member and one or more members that are downline from the at least one member within the merged multiline user structure.

14. The method of claim 1, wherein adding the additional lines is further based on online usage of a unique code associated with the at least one member, wherein the unique code is an embedded uniform resource location (URL) of a webpage.

15. The method of claim 14, wherein the online usage of the unique code is at the webpage, and further comprising generating a new unique code based on the online usage of the unique code at the webpage by a device of a new member.

16. The method of claim 15, further comprising creating a new relationship between the new member and the at least one member within the merged multiline user structure, and storing information regarding the new relationship in association with the new unique code.

17. The method of claim 14, further comprising identifying one or more relationships with one or more members that are upline from the at least one member within the merged multiline user structure based on the data for the at least one member.

18. The method of claim 17, further comprising associating the at least one member and the upline members with an online interaction based on usage of the unique code during the online interaction.

19. A system for merging at least two multi-level user structures into a multiline user structure, the system comprising:
a first non-multiline database that stores information regarding a first non-multiline user structure with a first set of lines corresponding to existing relationships;
a second non-multiline database that stores information regarding a second non-multiline user structure with a second set of lines corresponding to existing relationships;
a merger module in communication with the first non-multiline database and the second non-multiline database, wherein the merger module is executable by a processor to merge the first non-multiline user structure and the second non-multiline user structure to create a new merged multiline user structure that includes the at least one member, wherein the set of relationships of at least one member is integrated into and maintained within the merged multiline user structure; and
a multiline database that stores the merged multiline user structure in memory, wherein the merged multiline user structure is updateable to add one or more additional lines based on information from a global positioning system (GPS) of one or more new members associated with the one or more additional lines.

20. A non-transitory, computer-readable storage medium, having embodied thereon a program executable by a processor to perform a method for merging at least two multi-level user structures into a multiline user structure, the method comprising:
storing information in a database regarding at least a first non-multiline user structure with a first set of lines corresponding to existing relationships and a second non-multiline user structure with a second set of lines corresponding to existing relationships;
receiving data for at least one member of the first non-multiline user structure or the second non-multiline user structure, the data regarding at least a position of the at least one member within the respective non-multiline user structure and corresponding to a set of relationships of the at least one member;
merging the first non-multiline user structure and the second non-multiline user structure to create a new merged multiline user structure that includes the at least one member, wherein the set of relationships of the at least one member is integrated into and maintained within the merged multiline user structure; and
storing the merged multiline user structure in memory, wherein the merged multiline user structure is updateable to add one or more additional lines based on information from a global positioning system (GPS) of one or more new members associated with the one or more additional lines.
